(19) United States
(12) Patent Application Publication
(10) Pub. No.: US 2005/0201253 A1
(43) Pub. Date: Sep. 15, 2005

(54) Optical reproducing apparatus and method with automatic gain control

(75) Inventors: Chang-jin Yang, Yongin-si (KR); Sang-yeal Park, Suwon-si (KR); Young-im Joo, Seoul (KR); You-chan Woun, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/073,610

(22) Filed: Mar. 8, 2005

(30) Foreign Application Priority Data
Mar. 9, 2004 (KR) 2004-15778

(51) Int. Cl. G11B 7/00

(52) U.S. Cl. 369/124.1; 369/59.15

(57) ABSTRACT

An optical reproducing apparatus and method, with an automatic gain control therefor. The optical reproducing apparatus may include an optical pickup reading out data from an optical disk, an automatic gain controller operating in one of a first amplification mode and a second amplification mode, and a main controller controlling an amplification mode of the automatic gain controller according to the location of the optical pickup. In the first amplification mode, the automatic gain controller amplifies a gain of a RF signal read out by the optical pickup at a fixed amplification rate for a recoding area of the optical disk, and in the second amplification mode, the automatic gain controller adjusts adaptively an amplification rate according to an input level of the RF signal for a non-recording area of the optical disk.

### CROSS-REFERENCE TO RELATED APPLICATIONS

This application claims the benefit of Korean Patent Application No. 2004-15778, filed on Mar. 9, 2004, in the Korean Intellectual Property Office, the disclosure of which is incorporated herein by reference.

### BACKGROUND OF THE INVENTION

1. Field of the Invention

Embodiments of the present invention relate to optical reproducing apparatuses and methods, and more particularly, to an optical reproducing apparatus which is capable of improving a capability of reproducing data from an optical disk having a data-recording area and a non-recording area coexisting thereon, and an automatic gain control apparatus and method thereof.

2. Description of the Related Art

An optical reproducing and/or recording apparatus reads and/or writes data from/to an optical medium, e.g., an optical disk, by projecting laser beams onto a recording area of the optical medium using an optical pickup, collecting light reflected from the optical medium and detecting a variation in detected reflectivity. When an optical reproducing apparatus reads out data from an optical disk having a data-recording area and a non-recording area coexisting thereon, such as in a CD-R, a CD-RW, a DVD±R, a DVD±RW, and a DVD-RAM, it has to maintain a signal output from the optical pickup at a certain level, to reduce disturbance caused by deflection of the optical disk or a variation in an amount of the reflected light. For this, optical reproducing apparatuses includes an AGC (Automatic Gain Control) circuit to adjust a gain of a signal output from an optical pickup.

A RF signal gain control method, using the conventional AGC circuit, is as follows. A gain of an RF signal can be adjusted in a manner that a RF signal amplified by a voltage gain amplifier can be received, the level of the RF signal and a reference level can be compared, an amplification rate of the RF signal can be generated according to a result of the comparison, a condenser using a charge pump can be charged, and a gain of the voltage gain amplifier can be adjusted with a charged voltage to adjust a gain of the RF signal. As described above, the RF signal is maintained at a certain level by adjusting a gain of the voltage gain amplifier regardless of whether the optical pickup is located at a data-recording area of the optical disk or a non-recording area.

When the signal output from the optical pickup is maintained at a predetermined level using the AGC circuit, as described above, a capability of reproducing data from the optical disk can be improved. Especially, in the case of a DVD-RAM, enabling data to be recorded on both land and groove tracks, because disturbances caused by deflections of the land track and the groove track are reduced by the maintaining of the output from the optical pickup to a certain level using the AGC circuit, thereby, improving the reproducing performance.

However, if the RF signal is maintained at a certain level, by adjusting the gain of the voltage gain amplifier, regardless of the actual location of the optical pickup, an overload may occur at the beginning portion of the data-recording area, due to characteristic of the AGC circuit, as shown in FIG. 1. That is, the gain of the RF signal may become saturated due to electric charge remaining in the condenser. Therefore, it takes more time to match the level of RF signal, detected by the optical pickup, with the reference level and it becomes difficult to accurately read out data from the beginning portion of the data-recording area, thereby deteriorating the reproducing capability of the optical reproducing apparatus.

### SUMMARY OF THE INVENTION

Embodiments of the present invention have been developed to solve the above described problems. Accordingly, an aspect of the present invention is to provide an optical reproducing apparatus and method for controlling an amplification mode of an automatic gain controller adaptively, according to the actual location of an optical pickup, thereby improving a reproducing capability of an optical disk, and an automatic gain control method and apparatus thereof.

Additional aspects and/or advantages of the invention will be set forth in part in the description which follows and, in part, will be obvious from the description, or may be learned by practice of the invention.

To achieve the above and/or other aspects and advantages, embodiments of the present invention set forth a reproducing apparatus including a pickup reading out data from a medium as an RF signal, an automatic gain controller selectively operating in an amplification mode of one of a first amplification mode and a second amplification mode, wherein in the first amplification mode the automatic gain controller amplifies a gain of the RF signal at a fixed amplification rate, and in the second amplification mode the automatic gain controller adaptively adjusts the amplification gain for the RF signal according to an input level of the RF signal and a main controller controlling the amplification mode of the automatic gain controller according to a location of the pickup relative to the medium, with the main controller operating the automatic gain controller in the second amplification mode when the pickup is located at a non-recording area of the medium, and the main controller operating the automatic gain controller in the first amplification mode when pickup is located at a data-recording area of the medium.

The reproducing apparatus may further include a digital signal processor constructing a corresponding RF signal, gain-adjusted by the automatic gain controller into a predetermined unit, and generating a predetermined event signal in response to the data construction in the predetermined unit, wherein the main controller controls the automatic gain controller to operate in the first amplification mode when the optical pickup is displaced from the non-recording area to the recording area and the event signal is generated. Further, the generating of the predetermined unit may include generating reproducing error-corrected data by using the gain-adjusted RF signal, as an ECC (Error Correction Code) block unit.

The reproducing apparatus may further include a signal generator generating a signal indicating whether data is recorded at the location of the optical pickup based on a level of the gain-adjusted RF signal, wherein the main controller determines whether the location where the optical pickup is located is the data-recording area or the non-recording area based on the signal output from the signal generator.

The medium may also be at least one of a CD-R, a CD-RW, a DVD±R, a DVD±RW, and/or a DVD-RAM.

To achieve the above and/or other aspects and advantages, embodiments of the present invention set forth an automatic gain controller, including a voltage gain amplifier amplifying a gain of a RF signal output from a pickup in a set amplification mode, and a gain controller setting the amplification mode of the voltage gain amplifier according to operate in selectively one of a first amplification mode and a second amplification mode based on the pickup being in a medium's data recording area or non-data recording area, respectively.

The first amplification mode may control the gain according to a fixed amplification rate and the second amplification mode may adaptively control the gain according to an input level of the RF signal. Further, the amplification mode selection may be based on generation of an ECC (Error Correction Code) block unit from the RF signal.

To achieve the above and/or other aspects and advantages, embodiments of the present invention set forth a reproducing apparatus comprising automatic gain controller embodiments of the present invention.

To achieve the above and/or other aspects and advantages, embodiments of the present invention set forth an automatic gain control method of a reproducing apparatus having an automatic gain controller for adjusting a gain of a RF signal read by a pickup, the method including reading out data from a medium using the pickup, according to a reproducing command signal, as the RF signal, amplifying a gain of the RF signal in a set amplification mode, and adaptively and selectively setting the amplification mode to one of a first amplification mode and a second amplification mode according to a location of the pickup, the first amplification mode amplifying the gain of the RF signal at a fixed amplification rate, the second amplification mode adaptively adjusting the gain according to an input level of the RF signal.

The setting of the amplification mode may set the second amplification mode when the pickup is determined to be located at a non-recording area of the medium, and may set the first amplification mode when the pickup is determined to be located at a data-recording area of the medium. The location of the pickup may also be determined based on a level of the gain-adjusted RF signal.

The automatic gain control method may further include constructing the gain-adjusted RF signal into a predetermined unit and generating an event signal in response to the predetermined unit construction, wherein the setting of the amplification mode sets the first amplification mode when the pickup is displaced from the non-recording area to the data-recording area and the event signal is generated.

The generating of the predetermined unit may include generating reproducing error-corrected data by using the gain-adjusted RF signal, as an ECC (Error Correction Code) block unit. In addition, the medium may be at least one of a CD-R, a CD-RW, a DVD±R, a DVD±RW, and/or a DVD-RAM.

To achieve the above and/or other aspects and advantages, embodiments of the present invention set forth an automatic gain controlling method, including amplifying a gain of a RF signal in a set amplification mode, and setting the amplification mode to operate in selectively one of a first amplification mode and a second amplification mode based on a pickup, corresponding to the RF signal, being in a medium's data recording area or non-data recording area, respectively.

The first amplification mode may control the gain according to a fixed amplification rate and the second amplification mode may adaptively control the gain according to an input level of the RF signal. In addition, the amplification mode selection may be based on generation of an ECC (Error Correction Code) block unit from the RF signal.

To achieve the above and/or other aspects and advantages, embodiments of the present invention set forth a reproducing method including automatic gain controlling method embodiments of the present invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a variation in a gain of a RF signal adjusted by an automatic gain control (AGC) circuit in a conventional optical reproducing apparatus;

FIG. 2 is a block diagram schematically illustrating an optical reproducing apparatus, according to an embodiment of the present invention;

FIG. 3 is an illustration explaining an operation of the automatic gain controller of FIG. 2, according to an embodiment of the present invention; and

FIG. 4 is a flowchart showing exemplary operations of an automatic gain control method, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described below to explain the present invention by referring to the figures.

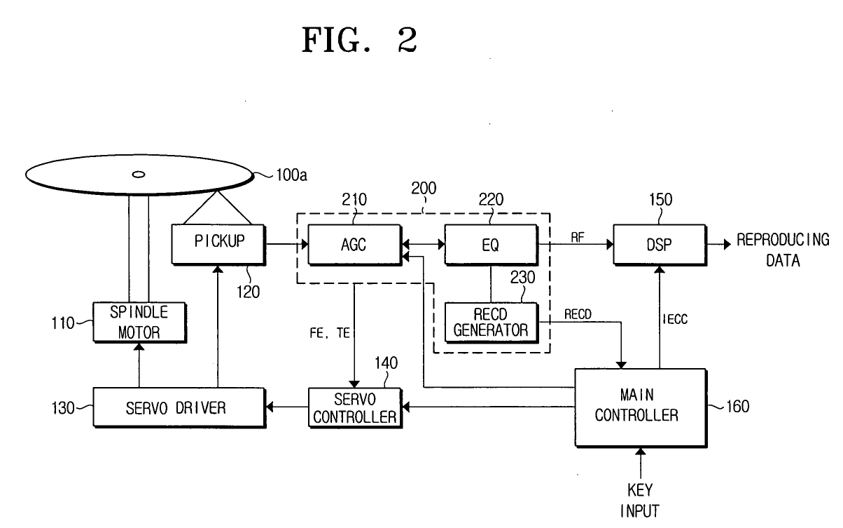

FIG. 2 is a block diagram illustrating an optical reproducing apparatus, according to an embodiment of the present invention.

Referring to FIG. 2, the optical reproducing apparatus includes an optical disk 100a, a spindle motor 110, a pickup 120, a servo driver 130, a servo controller 140, a digital signal processor (DSP) 150, a main controller 160, and a RF signal processor 200.

Such optical reproducing apparatuses for reproducing data from the optical disk 100a may include a CDP (Compact Disc Player) and a DVDP (Digital Versatile Disc Player), for example. In this embodiment, the optical disk 100a is an optical recording medium that has coexisting data-recording and non-recording areas, and may correspond to a CD-R (CD-Recordable), a DVD±R, a CD-RW (CD-Rewritable), a DVD±RW, and a DVD-RAM, for example.

The spindle motor 110, which can be a DC motor rotating a loaded optical disk 100a at a predetermined speed, rotates the optical disk 100a in response to a driving voltage supplied from the servo driver 130.

The pickup 120 reads out data from the optical disk 100a by projecting laser beams onto the optical disk 100a and collecting light reflected from the optical disk 100a. For this, the pickup 120 can include a laser diode employed as a light source, an object lens, a focus actuator, a tracking actuator, and a photodiode employed as a light detector.

The servo driver 130 controls the driving of the spindle motor 110 and the pickup 120, according to the control of the servo controller 140. For this, the servo driver 130 includes a motor driver for controlling the driving of the spindle motor 110, a focusing driver for controlling the driving of the focus actuator, and a tracking driver for controlling the driving of the tracking actuator.

The RF signal processor 200 generates an RF sum signal (hereinafter, referred to as the RF signal), a focus error (FE) signal, and a tracking error (TE) signal, based on electric signals output from the pickup 120. The FE and the TE signals generated by the RF signal processor 200 can be supplied to the servo controller 140 to control focusing and tracking actuators of the pickup 120.

The RF signal processor 200 includes an automatic gain controller (AGC) 210 for adjusting a gain of the RF signal and an equalizer (EQ) 220 for equalizing the RF signal gain-adjusted by the AGC 210.

The RF signal processor 200 further includes a recorded area (RECD) generator 230 for generating a recorded area (RECD) signal based on the RF signal, as filtered by the EQ 220, and outputting the generated RECD signal to the main controller 160. The RECD signal can be a binarized signal of the RF signal filtered by the EQ 220, divided into a signal detected from the data-recording area of the optical disk 100a and a signal detected from the non-recording area. The RECD generator 230 outputs a ‘high’ signal as the RECD signal, if an output signal from the EQ 220 is determined to be corresponding to the recording area, while outputting a ‘low’ signal as the RECD signal if an output signal from the EQ 220 is determined to be corresponding to the non-recording area.

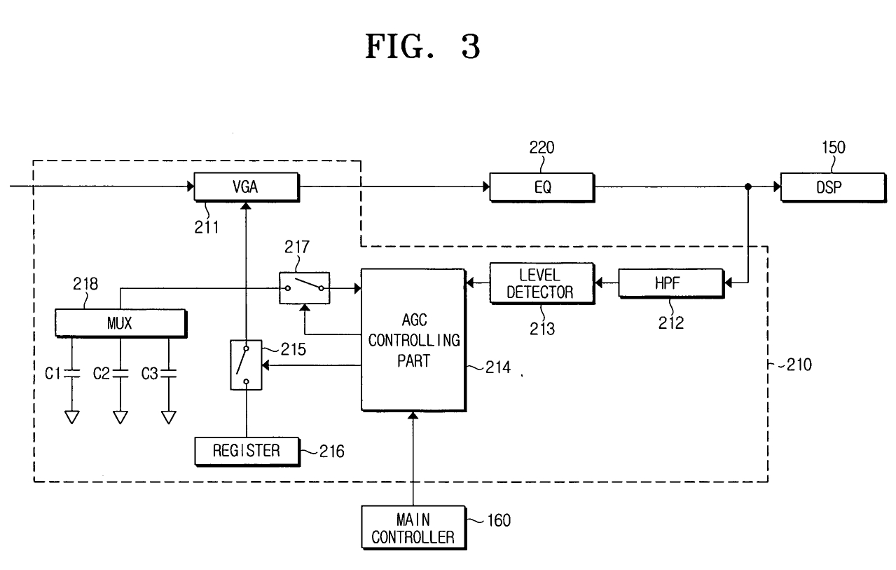

FIG. 3 is illustrates an operation of the AGC 210 of FIG. 2, according to an embodiment of the present invention.

Referring to FIG. 3, the AGC 210 may include a voltage gain amplifier (VGA) 211, a high pass filter (HPF) 212, a level detector 213, an AGC controlling part 214, a first switching part 215, a second switching part 217, and a multiplexer (MUX) 218.

The VGA 211 adjusts a gain of the RF signal, output from the pickup 120, according to the control of the AGC controlling part 214. According to an embodiment of the present invention, the VGA 211 can be operated selectively in a first amplification mode or a second amplification mode, according to the control of the AGC controlling part 214. In the first amplification mode, the VGA 211 amplifies the gain of the RF signal output from the pickup 120 at a fixed amplification rate, and in the second amplification mode, the VGA 211 adjusts the amplification rate adaptively according to an input level of the RF signal.

The AGC controlling part 214 controls the switching operation of the first switching part 215 or the second switching part 217 based on a control signal supplied from the main controller 160 to set the amplification mode of the VGA 211. More specifically, the AGC controlling part 214 turns-on the first switching part 215 when supplied with an ‘AGC ON’ signal, as the control signal from the main controller 160, while turning on the second switching part 217 when supplied with an ‘AGC OFF’ signal from the main controller 160.

When the ‘AGC ON’ signal is supplied from the main controller 160, to turn on the first switching part 215, the amplification rate of the VGA 211 is fixed according to an amplification rate set in a register 216 connected to the first switching part 215. Namely, when the first switching part 215 is turned on, the VGA 211 is operated in the first amplification mode.

On the other hand, when the ‘AGC OFF’ signal is supplied from the main controller 160 to turn on the second switching part 217, the amplification rate of the VGA 211 is adjusted adaptively according to the level of the RF signal output from the EQ 220. Namely, when the second switching part 217 is turned on, the VGA 211 is operated in the second amplification mode.

The HPF 212 performs a high-pass filtering with respect to the RF signal output from the EQ 220 and outputs the filtered signal to the level detector 213.

The level detector 213 detects a peak-to-peak level of the RF signal supplied from the HPF 212. The level of the RF signal detected by the level detector 213 is supplied to the AGC controlling part 214.

The AGC controlling part 214 compares the level of the RF signal detected by the level detector 213 with a predetermined reference level, and controls the on/off switching operations of the second switching part 217 according to a result of the comparison. For this, the AGC controlling part 214 includes a charge pump (not shown) for charging one of a plurality of capacitors C1, C2, and C3, connected through the MUX 218, with a predetermined voltage to adjust the amplification rate of the VGA 211 according to the level of RF signal detected by the level detector 213.

The AGC controlling part 214 supplies the charge pump with the voltage to adjust the amplification rate of the VGA 211, according to the level of the RF signal detected by the level detector 213. The voltage supplied to the charge pump charges one of the plurality of capacitors C1, C2, and C3 connected to the MUX 218, corresponding to the optical disk for reproduction, and the voltage charging of the capacitor is used to adjust the amplification rate of the VGA 211. That is, when the VGA 211 is operated in the second amplification mode, the amplification rate of the VGA 211 is adaptively adjusted according to the voltage applied to one of the plurality capacitors C1, C2, and C3.

As described above, when the second switching part 217 is turned on, to operate the VGA 211 in the second amplification mode, the amplification rate of the VGA 211 is adaptively adjusted according to the level of the RF signal detected by the level detector 213 so that the level of the RF signal output from the DSP 150 can be maintained at a certain level, for example, about 0.6V to 1.6V.

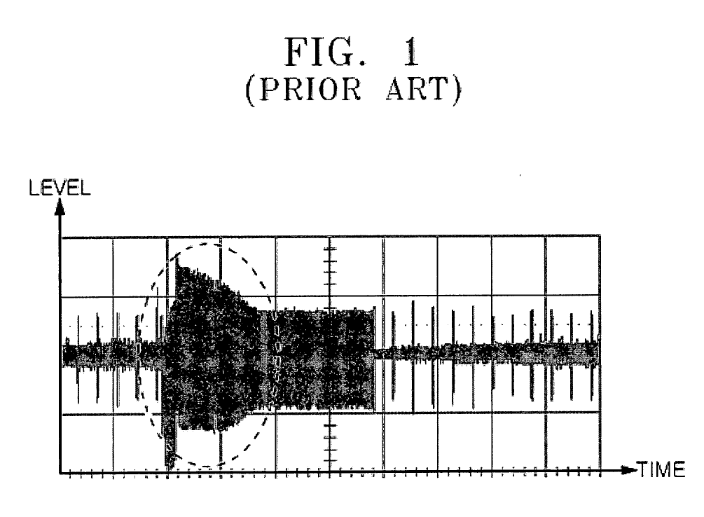

Referring back to FIG. 1, the DSP 150 performs a decoding and an error correction with respect to the RF signal outputted from the EQ 220 to generate a reproducing data. Generally, the DSP 150 constructs the RF signal output from the EQ 220 into ECC (Error Correction Code) block units. This is because data is recorded on the optical disk 100a in ECC block units. The DSP 150 outputs an event generation signal to inform the main controller 160 when the data of the ECC block units has been constructed, i.e., when a ECC block is constructed the optical pickup will be within the recording area, here the construction of 1 ECC block may be sufficient to identify that the RF signal now includes ECC block units, e.g., if the pickup has transitioned from the non-recording area to the recording area. Since the second amplification mode can maintain the RF signal near a certain level the DSP 150 may not be able to derive ECC block units from the RF signal since the maintained certain level may not be representative of ECC data.

The main controller 160 controls overall operation of the optical reproducing apparatus, according to a key manipulation signal input through a user's interface (not shown). For example, the main controller 160 controls the servo controller 140, the RF signal processor 200 and the DSP 150 to read out data from the loaded optical disk 100a in response to a reproducing command, and accordingly perform the conversion of the data to a reproducible signal.

The main controller 160 outputs to the AGC controlling part 214 a control signal to adjust the gain of the RF signal supplied from the pickup 120 based on the RECD signal, supplied from the RF signal processor 200 and the event generation signal supplied from the DSP 150. For example, when input with a ‘LOW’ signal, corresponding to the RECD signal from the RF signal processor 200, the main controller 160 determines that the pickup 120 is located at the non-recording area of the optical disk 100a and outputs an ‘AGC OFF’ signal to the AGC controlling part 214.

On the other hand, when the main controller 160 is input with a ‘HIGH’ signal, corresponding to the RECD signal from the RF signal processor 200, the main controller 160 determines that the pickup 120 is now located at the recording area of the optical disk 100a and outputs an ‘AGC ON’ signal to the AGC controlling part 214. Preferably, the main controller 160 outputs the ‘AGC ON’ signal to the AGC controlling part 214 when the pickup 120 is determined to have displaced from the non-recording area of the optical disk 100a to the recording area and when the event generation signal (for informing that the data of the at least 1 ECC block unit has been constructed) is received from the DSP 150.

Also, the main controller 160 outputs to the AGC controlling part 214 the control signal to adjust the gain of the RF signal supplied from the pickup 120, in response to a seek command. For example, when receiving the seek command to move the pickup 120 to a specific target track through the user's interface, the main controller 160 outputs the ‘AGC OFF’ signal to the AGC controlling part 214. After the pickup 120 moves to the target track, i.e., the seek operation is completed, the main controller 160 outputs the ‘AGC ON’ signal to the AGC controlling part 214 when the event generation signal is received. Accordingly, a stable data reproducing operation is possible even after the pickup 120 moves to a specific track upon the seek command.

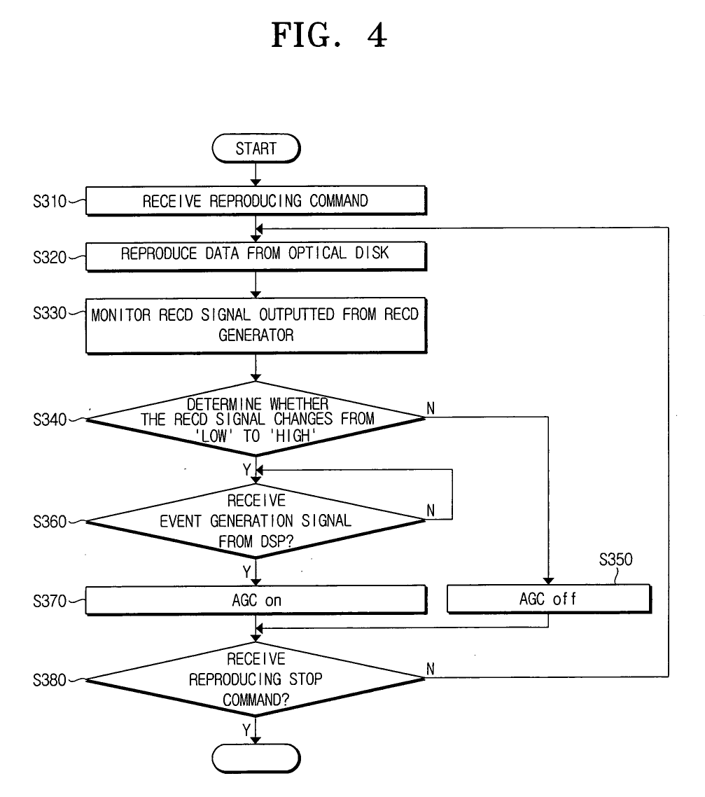

Hereinafter, an automatic gain control method of an optical reproducing apparatus, according to an embodiment of the present invention, will be described with reference to FIG. 4.

FIG. 4 is a flowchart showing exemplary operations of an automatic gain control method of the optical reproducing apparatus of FIG. 2, for example.

Referring to FIGS. 2 through 4, when a reproducing command is received from the user's interface (operation S310), the main controller 160 reproduces data from the loaded optical disk 100a (operation S320). The process of reproducing data from the optical disk 100a is as follows. First, the pickup 120 reads out data from the optical disk 100a and provides the data to the RF signal processor 200. Then, the RF signal processor 200 adjusts a gain of an RF signal received from the pickup 120 in a set amplification mode, and provides the gain-adjusted RF signal to the DSP 150. The DSP 150 generates reproducing data by performing signal processing, such as error correction, of the RF signal received from the RF signal processor 200.

The main controller 160 monitors the RECD signal output from the RECD generator 230 (operation S330), and determines whether the RECD signal changes from ‘LOW’ to ‘HIGH’ (operation S340). That is, the main controller 160 determines whether the pickup 120 has displaced from a non-recording area of the optical disk 100a to a recording area based on the RECD signal.

As a result of the determination, in operation S340, if the RECD signal output from the RECD generator 230 is a ‘LOW’ signal, the main controller 160 determines that the pickup 120 is now located within the non-recording area and outputs an ‘AGC OFF’ signal to the AGC controlling part 214 (operation S350). Upon receiving the ‘AGC OFF’ signal from the main controller 160, the AGC controlling 214 turns on the second switching part 217. In this case, the VGA 211 is then operated in the second amplification mode.

Meanwhile, in operation S340, if it is determined that the RECD signal output from the RECD generator 230 transitions from ‘LOW’ to ‘HIGH’, the main controller 160 determines that the pickup 120 has displaced from the non-recording area to the recording area, and determines whether an event generation signal (informing of data of at least 1 ECC block unit has been constructed) has been received from the DSP 150 (operation S360).

When the pickup 120 is determined to have displaced from the non-recording area to the recording area, and the event generation signal has been received from the DSP, i.e., indicating that data is being read out from the recording area, the main controller 160 outputs an ‘AGC ON’ signal to the AGC controlling part 214 (operation S370). Upon receiving the ‘AGC ON’ signal from the main controller 160, the AGC controlling part 214 turns on the first switching part 215. In this case, the VGA 211 will now be operated in the first amplification mode.

When a reproducing stop command is received through the user's interface, in the middle of the above operation (operation S380), the main controller 160 stops the reproducing operation. If no reproducing stop command is received, the operations of S320 through 360 can be repeated until a reproducing stop command is received.

As described above, according to embodiments of the present invention, the amplification mode of the VGA 211 of the AGC 210 is adaptively controlled according to the location of the pickup 120. Accordingly, when the pickup 120 changes from the non-recording area of the optical disk 100a to the recording area, the gain of the RF signal is prevented from becoming saturated by the electric charge remaining in the capacitor and thus an overload does not occur in the beginning portion of the recording area. That is, if it is determined that the pickup 120 is located on the non-recording area, the VGA 211 is operated in the second amplification mode so that the electric charge charged in the capacitor during the first amplification mode of the VGA 211 can be completely discharged.

According to an automatic gain control method embodiment, as described above, by controlling the amplification mode of the AGC 210, adaptively, according to the location of the pickup, the gain of the RF signal is prevented from becoming saturated when the pickup is displaced from the non-recording area to the recording area, and thus data can be stably read out from the beginning part of the recording area. Accordingly, the data reproducing capability can be improved.

Although a few embodiments of the present invention have been shown and described, it would be appreciated by those skilled in the art that changes may be made in these embodiments without departing from the principles and spirit of the invention, the scope of which is defined in the claims and their equivalents.

1. A reproducing apparatus comprising:
a pickup reading out data from a medium as an RF signal;
an automatic gain controller selectively operating in an amplification mode of one of a first amplification mode and a second amplification mode, wherein in the first amplification mode the automatic gain controller amplifies a gain of the RF signal at a fixed amplification rate, and in the second amplification mode the automatic gain controller adaptively adjusts the amplification gain for the RF signal according to an input level of the RF signal; and
a main controller controlling the amplification mode of the automatic gain controller according to a location of the pickup relative to the medium, with the main controller operating the automatic gain controller in the second amplification mode when the pickup is located at a non-recording area of the medium, and the main controller operating the automatic gain controller in the first amplification mode when pickup is located at a data-recording area of the medium.

2. The reproducing apparatus of claim 1, further comprising a digital signal processor constructing a corresponding RF signal, gain-adjusted by the automatic gain controller into a predetermined unit, and generating a predetermined event signal in response to the data construction in the predetermined unit, wherein the main controller controls the automatic gain controller to operate in the first amplification mode when the optical pickup is displaced from the non-recording area to the recording area and the event signal is generated.

3. The reproducing apparatus of claim 2, wherein the generating of the predetermined unit comprises generating reproducing error-corrected data by using the gain-adjusted RF signal, as an ECC (Error Correction Code) block unit.

4. The reproducing apparatus of claim 1, further comprising a signal generator generating a signal indicating whether data is recorded at the location of the optical pickup based on a level of the gain-adjusted RF signal, wherein the main controller determines whether the location where the optical pickup is located is the data-recording area or the non-recording area based on the signal output from the signal generator.

5. The reproducing apparatus of claim 1, wherein the medium is at least one of a CD-R, a CD-RW, a DVD±R, a DVD±RW, and/or a DVD-RAM.

6. An automatic gain controller, comprising:
a voltage gain amplifier amplifying a gain of a RF signal output from a pickup in a set amplification mode; and
a gain controller setting the amplification mode of the voltage gain amplifier according to operate in selectively one of a first amplification mode and a second amplification mode based on the pickup being in a medium's data recording area or non-data recording area, respectively.

7. A reproducing apparatus comprising the automatic gain controller of claim 6.

8. The automatic gain controller of claim 6, wherein the first amplification mode controls the gain according to a fixed amplification rate and the second amplification mode adaptively controls the gain according to an input level of the RF signal.

9. The automatic gain controller of claim 6, wherein the amplification mode selection is based on generation of an ECC (Error Correction Code) block unit from the RF signal.

10. An automatic gain control method of a reproducing apparatus having an automatic gain controller for adjusting a gain of a RF signal read by a pickup, the method comprising:
reading out data from a medium using the pickup, according to a reproducing command signal, as the RF signal;
amplifying a gain of the RF signal in a set amplification mode; and
adaptively and selectively setting the amplification mode to one of a first amplification mode and a second amplification mode according to a location of the pickup, the first amplification mode amplifying the gain of the RF signal at a fixed amplification rate, the second amplification mode adaptively adjusting the gain according to an input level of the RF signal.

11. The automatic gain control method of claim 10, wherein the setting of the amplification mode sets the second amplification mode when the pickup is determined to be located at a non-recording area of the medium, and sets the first amplification mode when the pickup is determined to be located at a data-recording area of the medium.

12. The automatic gain control method of claim 11, wherein the location of the pickup is determined based on a level of the gain-adjusted RF signal.

13. The automatic gain control method of claim 10, further comprising constructing the gain-adjusted RF signal into a predetermined unit and generating an event signal in response to the predetermined unit construction, wherein the setting of the amplification mode sets the first amplification mode when the pickup is displaced from the non-recording area to the data-recording area and the event signal is generated.

14. The automatic gain control method of claim 13, wherein the generating of the predetermined unit comprises generating reproducing error-corrected data by using the gain-adjusted RF signal, as an ECC (Error Correction Code) block unit.

15. The automatic gain control method of claim 10, wherein the medium is at least one of a CD-R, a CD-RW, a DVD±R, a DVD±RW, and/or a DVD-RAM.

16. An automatic gain controlling method, comprising:
amplifying a gain of a RF signal in a set amplification mode; and
setting the amplification mode to operate in selectively one of a first amplification mode and a second amplification mode based on a pickup, corresponding to the RF signal, being in a medium's data recording area or non-data recording area, respectively.

17. A reproducing method comprising the automatic gain controlling method of claim 16.

18. The automatic gain controlling method of claim 16, wherein the first amplification mode controls the gain according to a fixed amplification rate and the second amplification mode adaptively controls the gain according to an input level of the RF signal.

19. The automatic gain controlling method of claim 16, wherein the amplification mode selection is based on generation of an ECC (Error Correction Code) block unit from the RF signal.
